(19) United States
(12) Patent Application Publication
(10) Pub. No.: US 2002/0099601 A1
(43) Pub. Date: Jul. 25, 2002

(54) Loyalty-based program for higher education finance assistance

(76) Inventor: Mark Farrell, Ottawa (CA)

Correspondence Address: LAW OFFICES OF MICHAEL DRYJA, 704 228TH AVENUE NE, PMB 694, SAMMAMISH, WA, 98074, US

(21) Appl. No.: 09/681,138

(22) Filed: Jan. 22, 2001

(51) Int. Cl. G06F 17/60

(52) U.S. Cl. 705/14

(57) ABSTRACT

A loyalty- and incentive-based program for assisting higher-education financing is disclosed. A user performs predetermined loyalty-based activities, such as purchasing goods or services from associated merchants. In exchange, the user receives points that are redeemable only to assist one or more individuals other than the user pay for higher-education costs, such as tuition, books, and supplies. The user redeems the points to assist these other individuals pay for their higher education.

### BACKGROUND OF INVENTION

This invention relates generally to loyalty- and incentive-based programs, and more particularly to such programs designed to assist higher-education financing.

Incentive- and loyalty-based programs, which are terms used interchangeably in this application, are used in applications as diverse as direct marketing activities, customer and employee loyalty solutions, and promotional activities. In general, a user of an incentive-based program performs predetermined activities. In exchange for successfully completing these activities, the user receives an award. As a direct marketing tool, an incentive-based program can be used to increase user response. For example, as an incentive for responding to a direct marketing offer, the user may receive an award. An incentive-based program can also be used to increase customer or employee loyalty as a loyalty solution, or to promote newly available or existing products or services as a promotional tool.

Incentive-based programs have also benefited from the popularity of the Internet. Many electronic commerce (e-commerce) companies are using incentive-based programs as a way to promote their businesses, and attract new customers. Incentive-based programs have also been established that use the Internet. One popular approach is to utilize an artificial currency such as “points.” Users who perform incentive-based activities receive points, and can redeem them for products or services offered by merchants that accept the currency.

### SUMMARY OF INVENTION

The invention relates to a loyalty-based program for assisting higher-education financing. A user performs predetermined loyalty-based activities, such as purchasing goods or services from associated merchants. In exchange, the user receives points that are redeemable only to assist one or more individuals other than the user pay for higher-education costs, such as tuition, books, and supplies. The user thus redeems the points to assist these other individuals pay for their higher education.

The invention is unique in at least two respects. First, the points are redeemable only for the benefit of someone other than the user who initially earned the points. While the user earns the points by performing loyalty-based activities, he or she can only redeem them for the benefit of other individuals. Second, the points are redeemable only to assist the financing of higher education. The user cannot use the points for any purpose, or for purchase goods and services in general, but can only use the points to assist other individuals pay for higher-education costs.

Methods, systems, and machine-readable media of varying scope are encompassed by the invention. Other aspects, embodiments and advantages of the invention, beyond those described here, will become apparent by reading the detailed description and by referencing the drawings.

### BRIEF DESCRIPTION OF DRAWINGS

FIG. 1 is a diagram of a system according to an embodiment of the invention.

FIG. 2 is a flowchart of a method according to an embodiment of the invention.

FIG. 3 is a diagram of an example computerized device that can be used to implement the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, and other changes may be made without departing from the spirit or scope of the present invention. The following detailed description is, therefore, not to be taken in a limiting sense, and the scope of the present invention is defined only by the appended claims.

Overview

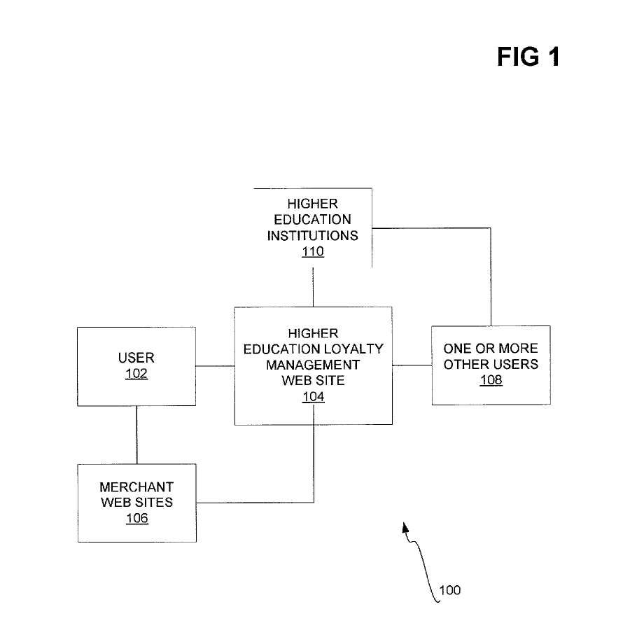

FIG. 1 is a diagram showing a system 100 according to an embodiment of the invention. The user 102 performs loyalty-based activities. For example, the loyalty-based activities can be purchasing predetermined goods and services from the merchant web sites 106. In exchange for performing the loyalty-based activities, the user 102 earns points in an account managed by the higher education loyalty management web site 104, where the user 102 has registered with the web site 104. When the user 102 has earned sufficient points, he or she can redeem the points at the web site 104 to assist the one or more other users 108 to pay for higher-education costs. For example, the higher-education costs can be tuition for the user 108 at the higher-education institutions 110. The costs can also include books and other supplies purchased through the higher-education institutions 110. It is noted that the user 102 him or herself does not receive any rewards, such as money or other benefits. All the rewards accrue for the benefit of the higher-education costs of the other users 108.

When redemption of points is desired by the user 102, the user 102 makes a request to redeem the points at the web site 104. The web site 104 processes this request. For example, the specified points are deducted from the account of the user 102, and are converted to a monetary value. The resulting amount of money can be sent directly to the users 108, or can be sent to the higher-education institutions 110. Furthermore, the money can be sent directly to a financial institution, at which one of the users 108 or one of the higher-education institutions 110 maintains an account. The money may also be sent in the form of a check, for instance, payable to both the institution and one of the users 108. Preferably, the rewards are sent in the form of points in increments of fifty dollars.

When the user 102 performs loyalty-based activities relative to the merchant web sites 106, this information is sent to the web site 104. This can be done in one of two ways. First, the merchant web sites 106 themselves can report back the purchases by the user 102, where the web sites 106 have desirably already been registered with the web site 104. Second, the user 102 can him or herself be responsible for reporting back purchases made at the web sites 106 to the web site 104. For example, the user 102 may furnish details regarding the purchases, and include receipts for verification purposes.

The web site 104 may have other capabilities in addition to managing the points earned by users such as the user 102. The web site 104 may have a realtime messaging capability, so users can interact among themselves as well as with operators of the web site 104 in real time. The web site 104 may also have computer bulletin and message board capabilities, for asynchronous, non-real-time messages among the users and the operators of the web site 104. The web site 104 may have electronic mail capabilities, and/or on-line communities capabilities, too.

There are two significant aspects regarding the system 100. First, the user 102 earns points for the benefit of someone other than the user 102, namely, the one or more other users 108. Second, the user 102 earns points only for the payment assistance of higher-education costs. The points earned by the user 102 can be redeemed only for assisting the one or more other users 108 pay higher-education costs. The points cannot be redeemed for the benefit of the user 102 him or herself, and also cannot be used for purposes other than for higher-education costs.

Method

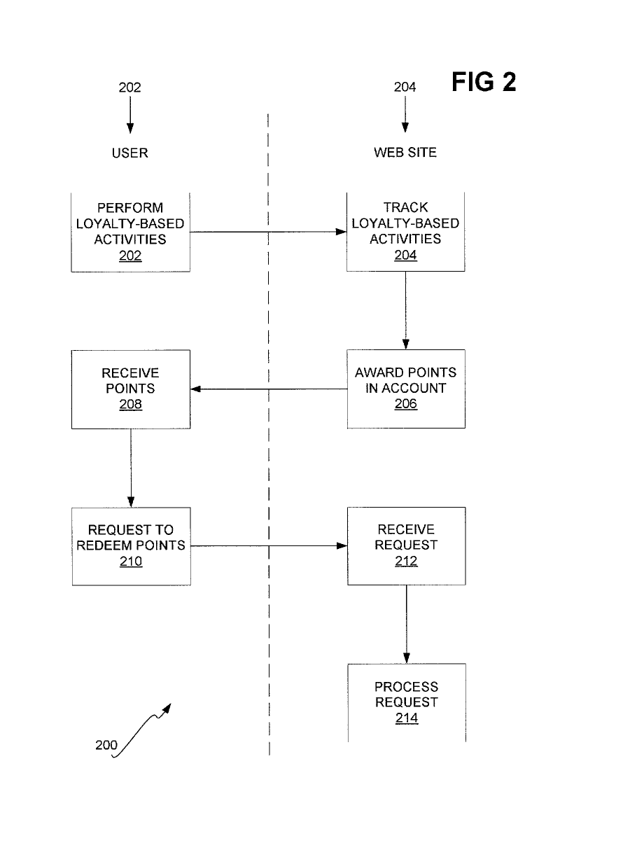

FIG. 2 shows a flowchart of a method 200 according to an embodiment of the invention. The parts of the method 200 performed by a user, such as the user 102 of FIG. 1, are identified by the column 202. The parts of the method 200 performed by a higher education loyalty management web site, such as the web site 104 of FIG. 1, are identified by the column 204. The method 200 can be performed in conjunction with the system 100 of FIG. 1.

In 202, the user performs loyalty-based activities, which can also be referred to as incentive-based activities. These activities are tracked by the loyalty management web site in 204. In exchange for the user performing the loyalty-based activities, the web site awards points in the user's account in 206, which are received by the user in 208. Periodically, once the user has earned a sufficient predetermined number of points, he or she can request to redeem the points in 210. The points can only be redeemed to assist one or more other users pay for their higher-education costs. The user him or herself receives no reward, such as reward money, in exchange for performing the loyalty-based activities. Furthermore, the points are preferably redeemed in increments of fifty dollars.

The loyalty management web site receives the request in 212, and processes the request in 214. For example, the web site may deduct the requested number of points from the user's account, and then convert these points to a monetary value. The resulting amount of money can be used to assist the one or more other users pay for higher-education costs, such as tuition, books, and supplies. The money may be sent directly to the one or more other users, or to the higher-education institution in question itself. For example, the money may be sent in the form of one or more checks, where each check is payable to both the higher-education institution and another user.The money may also be sent to a financial institution at which the other user or the higher-education institution maintains an account.

Example Computerized Device

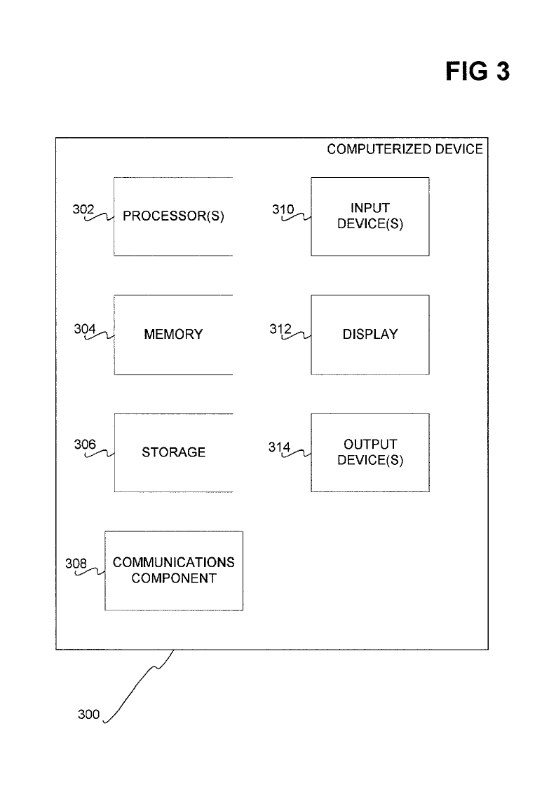

The invention can be implemented within a computerized environment having one or more computerized devices. The diagram of FIG. 3 shows an example computerized device 300. The example computerized device 300 can be, for example, a desktop computer, a laptop computer, or a personal digital assistant (PDA). The invention may be practiced with other computer system configurations as well, including multiprocessor systems, microprocessor-based or programmable consumer electronics, network computers, minicomputers, and mainframe computers. The invention may be practiced in distributed computing environments where tasks are performed by remote processing devices that are linked through a communications network.

The device 300 includes one or more of the following components: processor (s) 302, memory 304, storage 306, a communications component 308, input device(s) 310, a display 312, and output device(s) 314. For a particular instantiation of the device 300, one or more of these components may not be present. For example, a PDA may not have any output device(s) 314. The description of the device 300 is to be used as an overview of the types of components that typically reside within such a device, and is not meant as a limiting or exhaustive description.

The processor(s) 302 may include a single central-processing unit (CPU), or a plurality of processing units, commonly referred to as a parallel processing environment. The memory 304 may include read-only memory (ROM) and/or random-access memory (RAM). The storage 306 may be any type of storage, such as fixed-media storage devices and removable-media storage devices. Examples of the former include hard disk drives, and flash or other non-volatile memory. Examples of the latter include tape drives, optical drives like CD-ROM drives, and floppy disk drives. The storage devices and their associated computer-readable media provide non-volatile storage of computer-readable instructions, data structures, program modules, and other data. Any type of computer-readable media that can store data and that is accessible by a computer can be used.

The device 300 may operate in a network environment. Examples of networks include the Internet, intranets, extranets, local-area networks (LAN's), and wide-area networks (WAN's). The device 300 may include a communications component 308, which can be present in or attached to the device 300. The component 308 may be one or more of a network card, an Ethernet card, an analog modem, a cable modem, a digital subscriber loop (DSL) modem, and an Integrated Services Digital Network (ISDN) adapter. The input device(s) 310 are the mechanisms by which a user provides input to the device 300. Such device(s) 310 can include keyboards, pointing devices, microphones, joysticks, game pads, and scanners. The display 312 is how the device 300 typically shows output to the user. The display 312 can include cathode-ray tube (CRT) display devices and flat-panel display (FPD) display devices. The device 300 may provide output to the user via other output device(s) 314. The output device(s) 314 can include speakers, printers, and other types of devices.

The methods that have been described can be computer-implemented on the device 300. A computer-implemented method is desirably realized at least in part as one or more programs running on a computer. The programs can be executed from a computer-readable medium such as a memory by a processor of a computer. The programs are desirably storable on a machine-readable medium, such as a floppy disk or a CD-ROM, for distribution and installation and execution on another computer. The program or programs can be a part of a computer system, a computer, or a computerized device.

Conclusion

It is noted that, although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method performable by a user comprising:
performing predetermined loyalty-based activities;
in exchange for performing the predetermined loyalty-based activities, receiving points, the points redeemable only to assist one or more users other than the user pay higher-education costs; and,
redeeming the points to assist the one or more users other than the user pay the higher-education costs.

2. The method of claim 1, wherein performing predetermined loyalty-based activities comprises purchasing one or more products and services from one or more predetermined merchants.

3. The method of claim 1, wherein redeeming the points to assist the one or more users other than the user pay the higher-education costs comprises redeeming the points to assist the one or more users other than the user pay higher-education tuition at a predetermined educational institution.

4. The method of claim 1, wherein redeeming the points to assist the one or more users other than the user pay the higher-education costs comprises redeeming the points to assist the one or more users other than the user purchase books and other supplies through a predetermined educational institution.

5. The method of claim 1, wherein the points are redeemed in increments of fifty dollars.

6. A method comprising:
tracking predetermined loyalty-based activities performed by a user;
awarding points to an account of the user in exchange for the user having performed the predetermined loyalty-based activities, the points redeemable only to assist one or more users other than the user pay higher-education costs;
receiving a request from the user to redeem specified points from the account to assist the one or more users other than the user pay for the higher-education costs; and,
processing the request from the user to redeem the specified points from the account to assist the one or more users other than the user pay for the higher-education costs.

7. The method of claim 6, wherein processing the request comprises:
deducting the specified points from the account of the user; and,
paying for at least part of the higher-education costs by converting the specified points deducted to a monetary value.

8. The method of claim 7, wherein processing the request further comprises sending an amount of money equal to the monetary value to which the specified points deducted have been converted to assist the one or more users other than the user pay for the higher-education costs.

9. The method of claim 8, wherein sending the amount of money comprises sending the amount of money directly to the one or more users other than the user.

10. The method of claim 9, wherein the amount of money is sent as one or more checks payable to both a predetermined higher-education institution and each of the one or more users other than the user.

11. The method of claim 9, wherein the amount of money is sent to a financial institution at which the one or more users other than the user maintains an account.

12. The method of claim 8, wherein sending the amount of money comprises sending the amount of money directly to a predetermined higher-education institution.

13. The method of claim 12, wherein the amount of money is sent as one or more checks payable to both the predetermined higher-education institution and each of the one or more users other than the user.

14. The method of claim 12, wherein the amount of money is sent to a financial institution at which the predetermined higher-education institution maintains an account.

15. The method of claim 6, wherein tracking the predetermined loyalty-based activities performed by the user comprises receiving feedback from one or more predetermined merchants that the user has purchased one or more products and services therefrom.

16. The method of claim 6, wherein tracking the predetermined loyalty-based activities performed by the user comprises receiving a request from the user that the user has purchased one or more products and services from one or more predetermined merchants, the request including verifiable information that the user has purchased the one or more products and services from the one or more predetermined merchants.

17. The method of claim 6, wherein the higher-education costs comprise higher-education tuition at a predetermined educational institution.

18. The method of claim 6, wherein the higher-education costs comprise books and other supplies purchased through a predetermined educational institution.

19. The method of claim 6, wherein the method is performed by execution of a computer program stored on a machine-readable medium by a processor.

20. A system comprising:
a loyalty management web site at which a user is registered and at which the user is able to redeem earned points from an account only to assist one or more users other than the user pay higher-education costs; and,
one or more merchant web sites that have registered with the loyalty management web site such that purchases at the one or more merchant web sites by the user earns the user points, the one or more merchant web sites reporting back the purchases by the user to the loyalty management web site.

21. The system of claim 20, wherein the loyalty management web site has real-time messaging, computer bulletin and message board capabilities.

22. The system of claim 20, wherein the loyalty management web site has electronic mail capabilities.

23. The system of claim 20, wherein the loyalty management web site has on-line communities capabilities.
